(19) United States
(12) Patent Application Publication
(10) Pub. No.: US 2002/0129507 A1
(43) Pub. Date: Sep. 19, 2002

(54) Depth gauge device and kit for grading plow

(76) Inventor: Charles J. Vecchio, North Bellmore, NY (US)

Correspondence Address: George J. Brandt, Jr., 40 Ontario Road, Bellerose Village, NY, 11001, US

(21) Appl. No.: 09/812,128

(22) Filed: Mar. 19, 2001

(51) Int. Cl. G01C 7/02

(52) U.S. Cl. 33/625

(57) ABSTRACT

A depth gauge device for a grading plow or a paving machine includes a guide rail mountable to the plow or paver and on which is carried a slider block slidable to selected positions on the guide rail in correspondence to a plow cutting depth or a asphalt paving layer depth a telltale or curb feeler engaging a reference datum line at the grade site to indicate proper or improper grading depth, movement of a ground shoe used with the device on a paver being employed to indicate if a correct paving layer thickness is being laid down.

### BACKGROUND OF THE INVENTION

The present invention relates to a depth gauge device for a construction machine such as a grading plow and/or for a paving machine, the device having a feeler extending laterally therefrom to locate proximal a grade datum such as a curb or staked datum line of wire or cord and therewith give visual indication to the machine operator if, for example, the plow is following a proper line for producing an intended grading level or a paving machine laying down a proper paving material thickness.

Devices attachable to graders, bulldozers and like construction machines to aid the machine operator in monitoring a grade elevation at which the machine plow is working to see if same is correct are known. These devices are cumbersome to use, can present a problem for ease of viewing by the machine operator, and they do not readily allow for quick and simple modification of a grading plow for mounting of the device thereon with a kit of components useable with many ones of grading plows of different manufacturers. It also is important to maintain a proper paving level when using a paving machine. Adaptation of a kit form depth gauge device for plow use to use on a paving machine also is desirable.

### SUMMARY OF THE INVENTION

In accordance with the invention, the depth gauge device includes a guide rail mountable to a side end part of a grading plow, the guide rail, e.g., being attached at the rear side of a plow mold board proximal an end edge of the plow. Mounting of the guide rail can be with a plurality of brackets which have been affixed to the mold board, the bracket array being arranged to provide that a lower end of the guide rail is proximal a bottom of the plow located a short distance above a cutting edge of the plow. An upper guide rail end will locate proximal a top edge of the plow. The guide rail also is easily mountable on a structure part of a paving machine.

The invention provides a depth gauge device for a grading plow which is such as to be readily mountable on a wide range of grading plow types and plows of various manufacturers with no need for special grading plow modification. Further, installation is made with minimum need of machine tools and skilled labor. The foregoing is facilitated by provision of the device components in the form of a kit which can be shipped to a plow owner or contractor who can have his own labor force make the installation in a few hours and in the field at a job site, if necessary. The foregoing is equally applicable to the situation where a depth guide device is to be fitted to a paving machine.

The guide rail will have a side profile conforming with a shape of the plow, e.g., being curved for mounting on a curved plow, or straight for mounting on a flat plow such as that of a bulldozer, and for mounting on a paving machine structure part. The cross section of the guide rail preferably will be T-shaped.

A slide block is mounted slidably on the guide rail and can be slid to selected positions on the guide rail at locations between the lower and upper guide rail ends. The slide block carries a telltale or curb feeler extending laterally from the slide block and a distance beyond the side edge of the plow. Where the device is mounted on a paving machine, the telltale includes a rod extending from the slidable block, and an additional block carried on the rod, a ground engaging shoe being suspended from said additional block.

The slide block can be locked in a selected position on the guide rail, a selected position corresponding to a depth location below a grade datum at which the plow cutting edge locates. For example, a requirement for grading may be the cutting of grade elevation 12 inches below a grade datum line. This grade datum line could be the top face of a curb, or it could be a reference line of a wire or cord staked alongside the area being graded.

The vertical distance of 12 inches can be measured between the cutting edge tip and a location on the guide rail. The slide block then will be locked to the rail with the curb feeler centered as to the slide rail location. In this way, the curb feeler will engage on the upper face of the curb or on top of the reference line, and the plow operator will be able to confirm that the plow is cutting at the job required depth. In respect of the device used on a paving machine, the required distance involved in that task is measured up from the ground engaging shoe bottom to a location on the guide rail and the slide block set at that location.

In the course of start of a plow cut or during cutting, the curb feeler may be located above the curb face or reference line but the operator readily can observe such condition and adjust plow depth setting accordingly for completing the cut to, e.g., 12 inches.

The curb feeler preferably is an elongated flexible member normally of longitudinally disposed orientation. But because it is flexible, it can be deflected, e.g., upwardly when it engages the curb face and the plow cutting edge is located deeper from the reference line than the slide block selected position cut depth denotes. Particularly suited as a curb feeler is a coil spring.

The above, and other objects, features and advantages of the invention will become apparent from the following description read in conjunction with the accompanying drawings, in which like reference numerals designate the same elements.

### BRIEF DESCRIPTION OF THE DRAWINGS

In the drawings:

FIG. 1 is a perspective view showing the depth gauge riding on a curb and indicating the grading plow on which the depth gauge is fitted is at proper grade cut depth;

FIG. 2 is a fragmentary exploded perspective view showing the components comprising the depth gauge and the mounting of same at the, e.g., right side end of a plow;

FIG. 3 is a side elevation view of the guide rail showing its positioning on the rear side of a plow having a curved moldboard the slide block being fitted on the guide rail;

FIG. 4 is a elevation view of the FIG. 3 guide rail looking forward from behind the plowl, the feeler carried on the slide block being show engaged on a cut depth guide line, not all guide rail fixing brackets being shown;

FIG. 5 is an elevation view like FIG. 4 of another embodiment of guide rail for use on a plow having a flat or straight plow board such as the plow of a bulldozer;

FIG. 6 is a side elevation view of the FIG. 5 guide rail and slide block;

FIG. 7 is a top view of the FIG. 5 device;

FIG. 8 is a top front perspective view of an embodiment of the slide block;

FIG. 9 is a left side elevation view of the FIG. 8 block;

FIG. 10 is a top view of the FIG. 8 block;

FIGS. 11a and 11b are showings denotive of slide block moved positions indicative, respectively, that plow setting that is too deep and too shallow in respect of intended cut line setting of the plow;

FIG. 12 is a plan view of a kit arrangement containing the components comprising the device and enabling field modification of a grading plow for equipping it with the depth gauge device;

FIG. 13 is a front elevation view showing the guide rail and slidable block mountable to a paving machine and illustrating the ground engaging shoe of the device; and

FIG. 14 is a left side elevation of the FIG. 13 device.

### DESCRIPTION OF THE PRESENTLY PREFERRED EMBODIMENTS

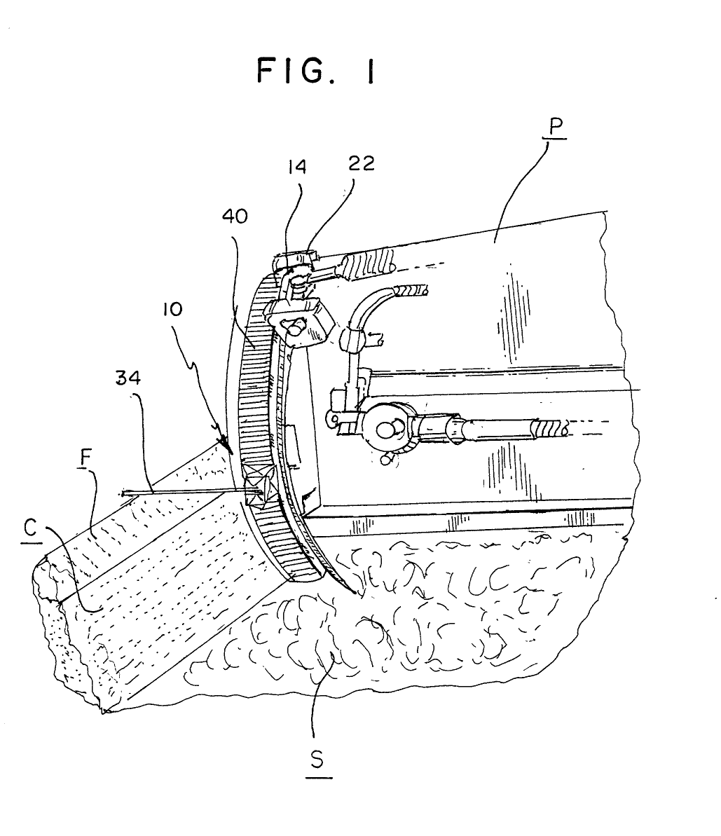

Referring to FIG. 1, grading plow P is working at the sidewall S of a curb C, a top face F of curb C defining a reference datum line (RDL) a distance below which, a grade cut is being made with plow P. The depth gauge device 10 of the invention enables the plow operator to monitor visually the cutting for proper depth and to make plow adjustments as necessary to produce the required elevation of cut grade.

Referring to FIGS. 1-4, depth gauge device 10 includes a series of brackets 12 which are affixed to the rear side of the mold board 14 of a grading plow P. The brackets can be affixed to studs 18 with nuts 19, the studs 18 being attached in suitable manner to, e.g., a reinforcing part 20 of mold board 14.

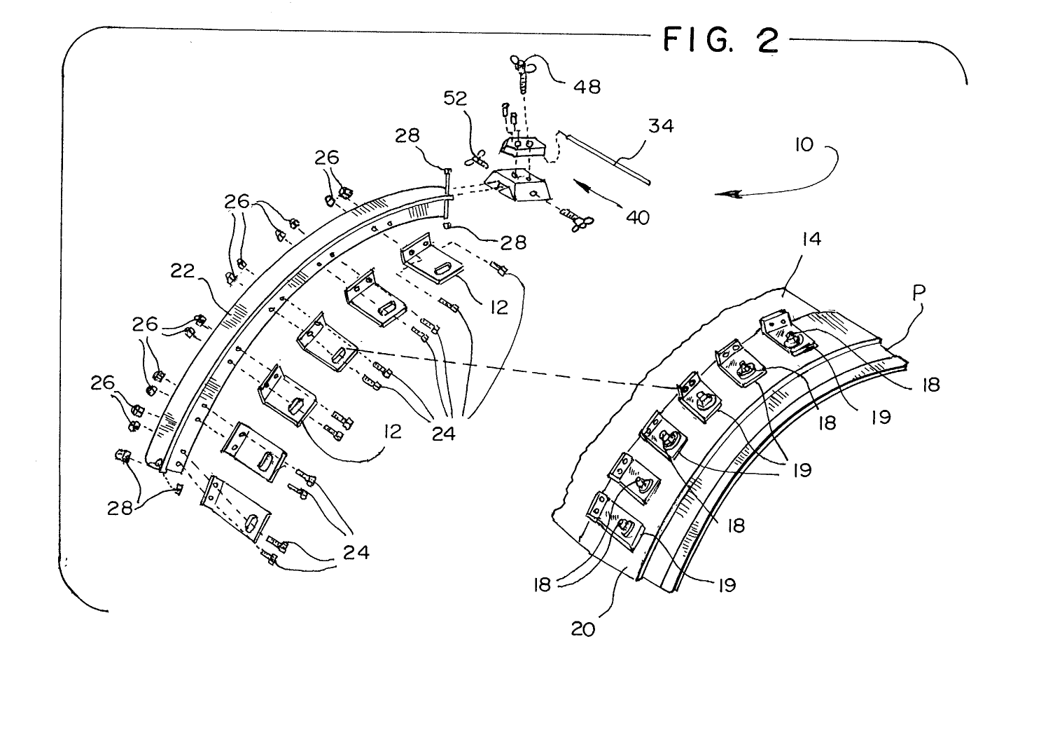

The brackets are arrayed from top to bottom of the mold board to allow mounting of guide rail 22 to the plow with a guide rail lower end proximal a bottom of the mold board and a guide rail upper end proximal a top edge of the mold board. The guide rail can extend slightly above the mold board top edge as seen in FIG. 2 but that is not essential.

The guide rail is removably mounted on brackets with bolts 24 and nuts 26. The guide rail is fitted with travel stops 28 and both the lower and upper ends thereof, these stops being, e.g., set screws and provided to stop travel of the below described slide block off the guide rail. The guide rail can be provided with graduations or markings on the front face, such graduations being related to values of a vertical distance from a selected position on the guide rail to the location of the cutting tip edge 32 of the plow. A selected position on the guide rail is that where a center line of a curb feeler 34 is located, the curb feeler being carried on slide block 40 described next.

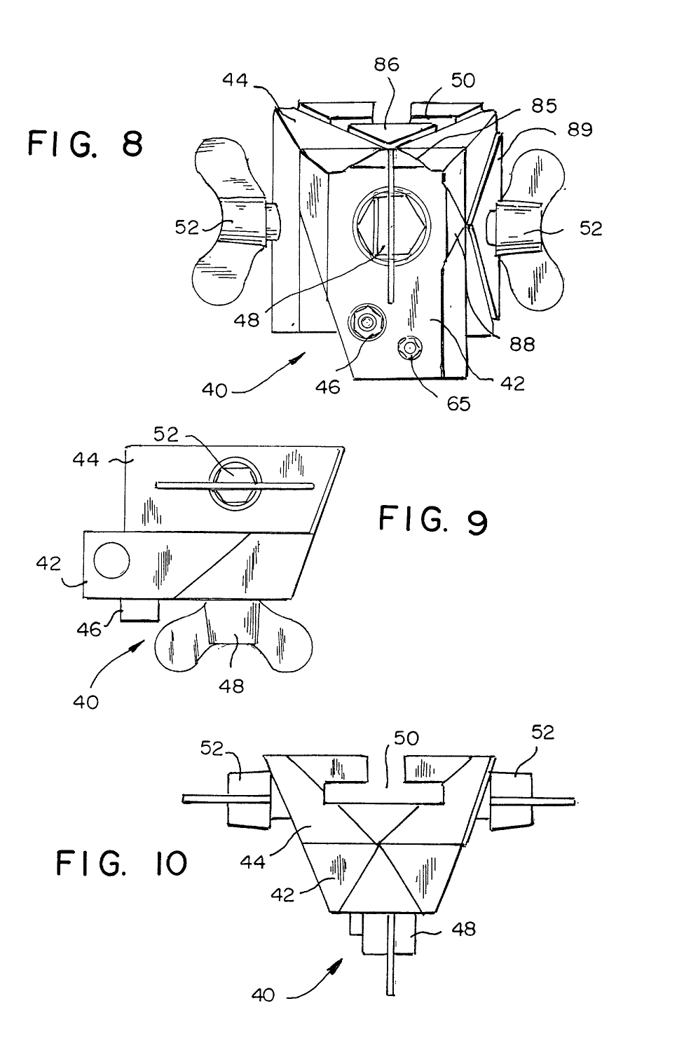

Referring additionally to FIGS. 8-10, slide block 40 can have a first front body part 42, and a second rear, wider and somewhat thicker body part 44, the body parts being secured together by a set screw 46 and a butterfly bolt 48. Second body part 44 is provided with a T-shaped slot 50 which receives the guide rail therein and by which the slide block can be slid along the guide rail. Side butterfly bolts 52 are used to lock the slide block at a selected position on the guide rail. A set screw 65 holds curb feeler 34 in place in the slide block 40.

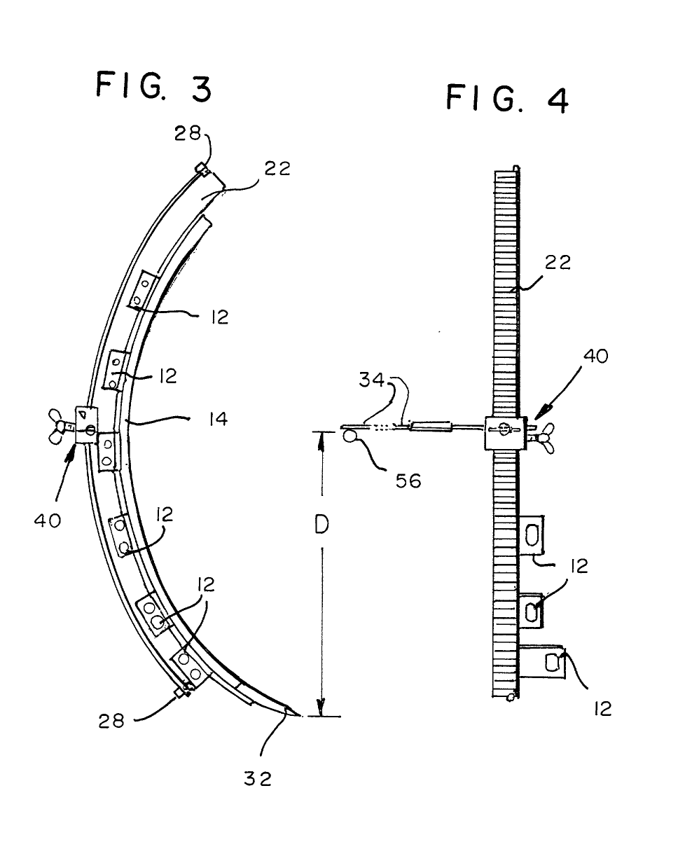

The upper face F of curb C can be the reference datum line RDL as noted above and with reference to FIG. 1. A wire or cord 56 staked alongside the area being graded also can serve as the RDL as shown in FIGS. 3 and 4. D is the vertical distance between the below elevation grade it is desired to cut and the RDL. When the grading has been carried out to the point where the curb feeler is riding the curb or the staked line, the operator knows the plow cutting edge is at the right elevation. This below grade elevation is that of the job requirement. The cut can, e.g., be one made to a base excavation depth for a road wherein gravel and finishing layers of concrete and/or asphalt will be laid down.

When the plow is operated to make a proper cut, the curb feeler 34 will run along the curb face F or on top of the wire or cord 56. If the curb feeler flexes upwardly, the operator would understand that this is indication that the plow cutting edge is too deep and needs to be raised. If the feeler is spaced a noticeable distance above the curb C or the staked wire 56, the operator will recognize that the plow is set too shallow and he will make adjustment to lower the plow until the feeler is again on the curb or wire.

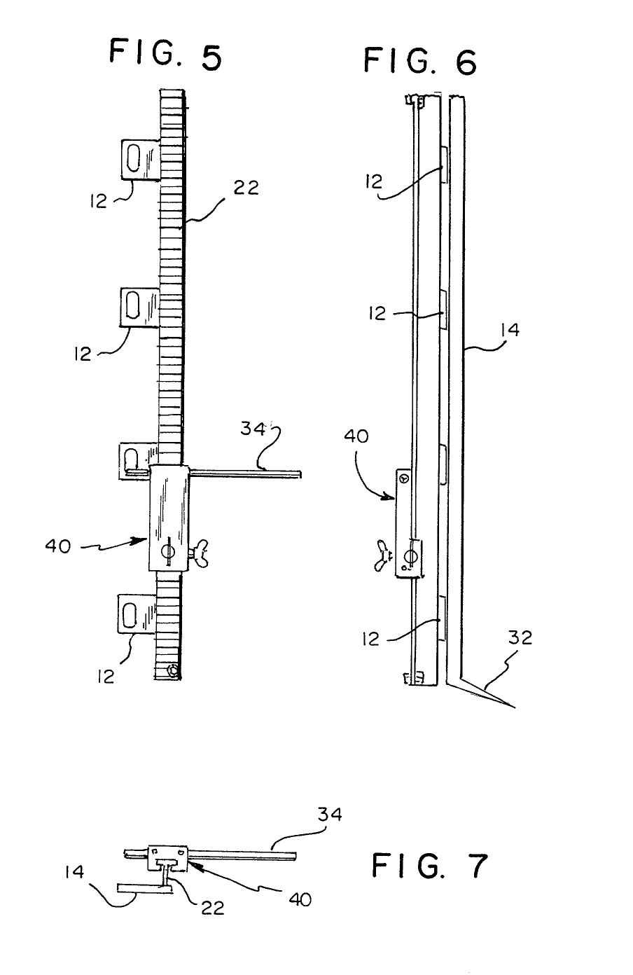

FIGS. 5-7 show a depth gauge device for a flat plow such as that of a bulldozer, the same parts designations as used in FIGS. 3 and 4 being employed in these Figs.

As noted above, the feeler 34 being a flexible member serves to indicate plow line departure from that intended, e.g., being too deep by flexing. Slide body 40 also serves to signal too shallow too deep plowing. Front body part 42 is rotatably mounted to rear body part 44. The two body parts can be locked as a unit with set screw 46. However, by loosening set screw 46, front body part is free to rotate on the rear body part to indicate departures up and down from intended cutting edge elevation and as will be discussed next with reference to FIGS. 11a and 11b.

The tops of front and rear body parts 42, 44 have respective triangles 85, 86 form thereon, these triangles being cooperative indicia markings. With feeler 34 set on the curb C or wire 56 and horizontally disposed, the apices of triangles 85, 86 are tip to tip facing. With set screw 62 loosened, and if the plow was set too shall, the front body part would rotate counterclockwise on the rear body part due to levering effect of the feeler 34. When that happens, the apices of triangles 85, 86 become spaced from each other as shown in FIG. 11a. The operator easily can observe this happening and compensate by lowering the plow. When that is done, the feeler will again engage the wire or curb and levering clockwise of the front body part will bring the apices of triangles 86,86 back into point-to-point registry. The right sides of the front and rear block body parts also have triangles 88, 89 formed thereon and these work in the same way as triangles 85,86 to give indication of proper plow depth or departure therefrom. The slide block depicted in FIGS. 11a and 11b is for mounting at the left side of a plow. A slide block for mounting at a plow right side will have a front side mirror image of the front side of a left side slide block. FIG. 11b depicts the front body part rotation that occurs when a plow is set too deep.

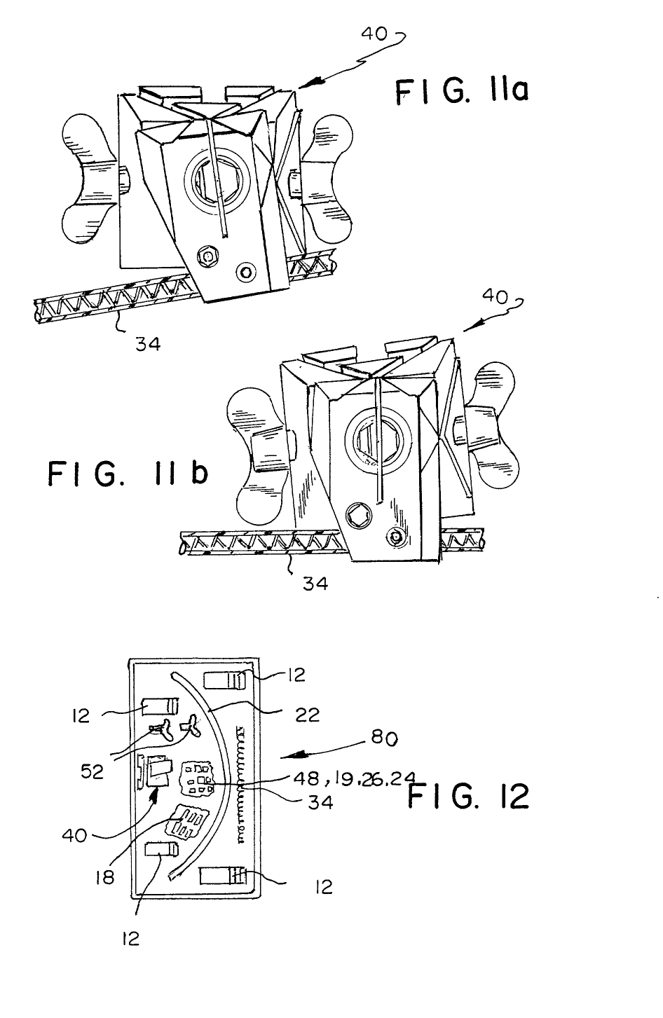

FIG. 12 depicts the provision of the components of which the depth gauge device as a kit 80 wherein the guide rail 22, brackets 12, butterfly set screws 52, bolt 48, nuts 19 and bolts 18, and nuts 26 and bolts 24 are furnished along with the curb feeler 34 and slide block 40. The kit 80 can be crated in a container and shipped to a customer for installation by the customer.

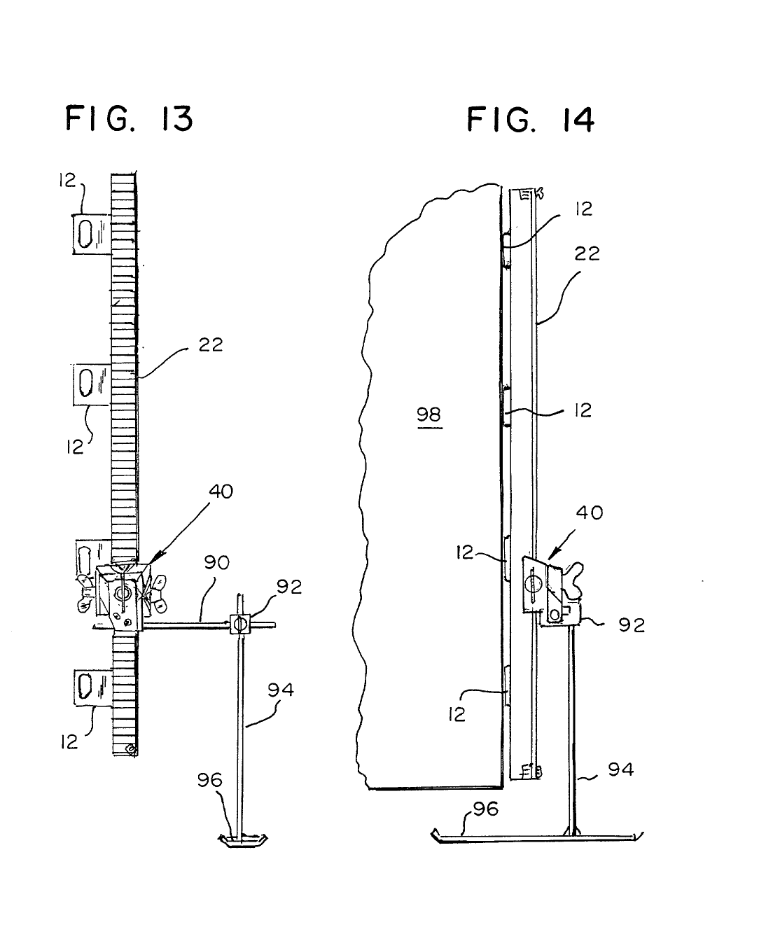

FIGS. 13 and 14 show an embodiment of the depth gauge device for installation on a paving machine. Guide rail 22 is removably mounted on a structure part 98 of a paving machine. A slide block 40 is mounted on the guide rail and functions as described above in respect of FIGS. 8-10. However, a flexible curb feeler is not carried in block front body part 42. Instead, it is replaced with a rigid rod 90, and an additional plain block 92 is slidable on rod 90. A vertical rod 94 is carried in block 92, and on the lower end thereof, carries a ground shoe 96. Set screws for holding rod 90 and rod 94 fixed in plain block 92 are provided though not shown in the Figs, for purpose of clarity of depiction of the other parts. The front body part of slide block 40 will pivot in the same manner as described above to signal if the paving layer being put down is too thick or too thin. For example, the ground shoe 96 can be set to appropriate elevation by adjustment of slide block 40 on the guide rail 22. This can be for the ground shoe to ride on a newly paved course so that by observation of the slide block indicia, maintenance of pavement material lay down to the correct thickness can be can be carried out.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. Depth gauge device for a grading plow comprising:
a guide rail mountable to a grading plow side end part with a lower end of said guide rail proximal a bottom of said plow and a guide rail upper end proximal a top of said plow;
a slide block mounted on said guide rail for moving said slide to selected positions on said guide rail between said guide rail lower and upper ends, said selected positions corresponding to depth locations of a plow cutting edge below a grade datum line;
means for locking said slide block in a selected position on said guide rail; and
a flexible feeler member extending laterally from said slide block beyond said plow side end part, for locating proximal a reference line defining said grade datum line so that visual observation of the closeness of the feeler to the said datum line can be used to ascertain if the plow cutting edge is at intended depth location relative to said datum line.

2. A depth gauge device according to claim 1, comprising a plurality of brackets fixable to a board of said plow, said guide rail being fixable to said brackets.

3. A depth gauge device according to claim 1, wherein said guide rail has a curved side profile for mounting on a substantially curved profile plow board.

4. A depth gauge device according to claim 1, wherein said guide rail has a straight side profile for mounting on a substantially flat plow board.

5. A depth gauge device according to claim 2, wherein said brackets are removably fixable to said plow board

6. A depth gauge device according to claim 1, wherein said feeler member is an elongated spring.

7. A depth gauge device according to claim 6, wherein said spring is a coil spring.

8. A depth gauge device according to claim 1, wherein said guide rail has a T-shaped cross section, the cross-piece of the T being spaced from the plow board, the slide block having a T-shaped slot for reception of the guide rail therein.

9. A depth gauge according to claim 8, wherein said slide block has a first block part containing said slot, and a second block part attached to said first part, said second block part being rotatable on said first block part.

10. A depth gauge according to claim 9, comprising releasable means on said second block engageable with said first block part for stopping a rotation of said second block part on said first block part.

11. A kit for installing a depth gauge device on a grading plow, said kit comprising:
a guide rail;
a plurality of brackets fixable to a side end part of said plow;
fasteners for fastening said guide rail to said brackets with a lower end part of the guide rail proximal a bottom of said plow and a guide rail upper end proximal a top of said plow;
a slide block mountable on said guide rail, said slide block being movable to selected positions corresponding to depth locations of a plow cutting edge below a grade datum line;
means for locking the slide block in a selected position on the guide rail; and
a flexible normally longitudinally disposed feeler member mountable to the slide block to extend laterally from said slide block beyond said plow side end part, an undeflected engagement of said feeler member with a reference line defining said grade datum line being denotive of the plow cutting edge being at a selected depth location.

12. A kit according to claim 11, wherein said guide rail has a curved side profile for mounting on a substantially curved profile plow board.

13. A kit according to claim 11, wherein said guide rail has a straight side profile for mounting on a substantially flat plow board.

14. A slide block mountable to a guide rail attached to a construction vehicle for indicating adherence of a part on said vehicle to a travel along an elevation fixed with respect to a grade datum, said slide block comprising: a block rear body part slidably receivable on said guide rail; means for locking said rear body part to said guide rail at selected locations between opposite ends of said guide rail; a block front body part rotably attached to said rear body part; a feeler extending laterally from said front body part for engaging on a reference mark member during vehicle travel; and indicia members carried on said rear and front body parts, said indicia on a body part having registry with the indicia on the other body part when the feeler is traveling on the reference mark, a disengagement of the feeler from the reference mark allowing said front body part to rotate on said rear body part and moving the indicia thereon out of registry.

15. A slide block according to claim 14, wherein said indicia comprise triangles formed on each body part, the indicia on said body parts having a registry with each other when apices of said triangles are in point-to-point juxtaposition.
